(19) United States
(12) Patent Application Publication
(10) Pub. No.: US 2026/0252385 A1
(43) Pub. Date: Aug. 27, 2026

(54) SCHEDULING METHOD OF DATA PREFETCHER FOR HANDLING INDIRECT ACCESSES

(71) Applicant: XI'AN JIAOTONG UNIVERSITY, Xi'an (CN)

(72) Inventors: Tian XIA, Xi'an (CN); Shaoru QU, Xi'an (CN); Zhongpei LUO, Xi'an (CN); Gelin FU, Xi'an (CN); Wenzhe ZHAO, Xi'an (CN); Pengju REN, Xi'an (CN)

(21) Appl. No.: 19/409,146

(22) Filed: Dec. 4, 2025

(30) Foreign Application Priority Data
Feb. 27, 2025 (CN) 2025102313193

(51) Int. Cl. G06F 9/48; G06F 9/30; G06F 9/38

(52) U.S. Cl. CPC G06F 9/4881; G06F 9/30047; G06F 9/3806

(57) ABSTRACT

A scheduling method of a data prefetcher for handling indirect accesses, including the steps of:
S100: constructing a data prefetcher that handles irregular accesses;
S200: implementing, with the data prefetcher, identification of an indirect access pattern and address prediction based on differential matching between index data and an indirect access address, and dividing indirect accesses into different range groups to perform prefetch scheduling according to the range groups. The method enhances the timeliness of prefetched data, improves the accuracy of data prefetching, and increases the coverage rate. Moreover, the method boasts an extremely low hardware resource overhead.

### CROSS-REFERENCE TO RELATED APPLICATION

This application claims priority from the Chinese patent application 2025102313193 filed Feb. 27, 2025, the content of which is incorporated herein in the entirety by reference.

### TECHNICAL FIELD

The present disclosure belongs to the technical field of processors and caches, and particularly relates to a scheduling method of a data prefetcher for handling indirect accesses.

### BACKGROUND OF THE DISCLOSURE

Modern CPU architectures often integrate the strengths of both the Von Neumann and Harvard architectures to optimize performance and memory access efficiency. In the Von Neumann architecture, program instructions and data are stored in the same memory space, and the CPU accesses them through a unified address bus. Conversely, the Harvard architecture separates instruction storage from data storage, and employs independent buses to access instructions and data in parallel, thereby reducing conflicts. Modern CPUs typically combine these approaches by utilizing a L1 instruction cache (L1 ICache) and a L1 data cache (L1 DCache) which are separate, enabling efficient access to both instructions and data while retaining the memory management style of the Von Neumann architecture. To further enhance performance, the CPU adopts a multi-level cache system (e.g., L1, L2, L3 caches). By leveraging a Cache Hit, the CPU reduces memory access latency. When a Cache Miss occurs, the CPU employs a Miss Status Handling Register (MSHR) to manage concurrent cache requests, ensuring efficient data scheduling and processing. This architectural design guarantees smooth handling of both instructions and data while significantly optimizing the access speed and response time. Particularly under high-frequency access demands, it markedly improves the execution efficiency of the overall system.

In the modern CPU, the execution of instructions is typically optimized through multi-level caches. First, when the CPU is ready to execute an instruction, it acquires the address of the current instruction via a program counter (PC) and searches for the instruction in the L1 instruction cache (L1 ICache). If the corresponding instruction is found in the L1 ICache (i.e., the Cache Hit), the CPU directly loads it into an instruction execution unit. If the Cache Miss occurs, the request is forwarded to higher-level caches such as L2, L3, or even ultimately to the main memory. When the Cache Miss occurs, after the data is acquired from the memory or a lower-level cache, it is then returned to the CPU for execution.

The data prefetcher is a critical hardware component in the modern CPU, and is designed to reduce latency caused by the Cache Miss by predicting the data that a program may access in the future and preemptively loading this data into the cache. It achieves this by analyzing cache access behaviors, particularly in cases of cache misses, to obtain the requested address information and generate access requests for future data based on predictive algorithms (such as linear prediction or analysis of historical access patterns). These predicted addresses are added to a prefetch queue, and after deduplication and timeliness checks, the requests are issued to the memory or the lower-level cache. In the event of the Cache Miss, the prefetched data is stored in the idle space of the cache. When the program actually requires the data, it is already present in the cache and can be returned directly to the CPU as a Cache Hit, thereby avoiding the high latency associated with memory access. The data prefetcher can effectively enhance system performance by reducing the idle time of the CPU caused by waiting for data and optimizing cache utilization. However, the prefetching mechanism also presents challenges. For instance, excessive prefetching may lead to a waste of cache resources, while incorrect predictions may result in the storage of useless data in the cache, affecting the access to other important data. Therefore, the design of the data prefetcher requires a balance between the prediction accuracy and the efficient utilization of the cache space to maximize the execution efficiency of the system.

The Compressed Sparse Row (CSR) format is an efficient storage mode for sparse matrices, particularly suitable for scenarios where the majority of elements in the matrix are zero. In the CSR format, the non-zero elements of the matrix are compactly stored in three arrays: the val array stores the non-zero elements of the matrix; the colidx array stores the column indices corresponding to each non-zero element; and the rowptr (row pointer) array stores the positions in the val array where the first non-zero element of each row is located. In this way, the CSR format significantly reduces the memory space and accelerates access to sparse matrices. In sparse matrix-vector multiplication, the sparse matrix needs to index into elements of a vector for multiplication and accumulation operations, the rowptr array is used to locate the non-zero elements of each row in the sparse matrix, while the colidx array is used to index the corresponding elements in the vector, enabling the multiplication and accumulation operations to be performed and yielding the computational results.

Breadth-First Search (BFS) is a graph traversal algorithm that begins at an initial node. It first accesses all the adjacent nodes of this starting node, and then sequentially accesses the unaccessed adjacent nodes of those accessed adjacent nodes, expanding layer by layer until all reachable nodes have been traversed. BFS employs a queue to access nodes layer by layer. This ensures that nodes accessed earlier are processed first. The algorithm is commonly used to solve problems such as finding the shortest path, determining graph connectivity, and performing level-order traversal. Due to its layer-by-layer expansion, BFS can guarantee finding the shortest path from the starting node to a target node, making it particularly suitable for solving shortest-path problems in unweighted graphs.

In the hierarchical memory structure of the modern CPU, the data requests between each level of cache and the memory system (such as L1, L2, and L3 caches, and main memory) are exchanged through dedicated data pathways. To efficiently manage data streams and optimize system performance, certain functional units can snoop these data pathways, enabling real-time reading and analysis of the information transmitted over them. The purpose of snooping is to filter out information critical to the system operation from the vast data streams and pass this information to other relevant functional units for further processing. For instance, within a CPU cache system, a snooping unit may monitor requests at each cache level, including information on Cache Hits and Misses, and adjust cache replacement policies, data prefetching strategies, or cache coherence policies based on this information. Additionally, the snooping unit can dynamically adjust the priority of memory access according to program behaviors or trigger corresponding optimization operations (such as initiating data prefetching or modifying cache strategies) when specific events occur. Snooping is not limited to caches, it may also involve interactions with other hardware resources, such as bus monitoring and instruction scheduling. The snooping function is particularly crucial in multi-core processors and complex memory hierarchy systems, as it helps the CPU better adapt to program behavior patterns, improve cache hit rates, and reduce access latency, thereby enhance overall computational efficiency. Through effective snooping and management of data pathways, the CPU can achieve more intelligent resource allocation and optimization decisions in dynamic and ever-changing execution environments.

Indirect access is a common irregular memory access pattern that typically arises in scenarios where data are accessed based on dynamically computed addresses. The basic form of indirect access involves using an index array (e.g., a[i]) to calculate the access address of another array (e.g., x), as in the expression of x[a[i]. In this case, a[i] does not represent a fixed address; rather, it is dynamically generated through certain computations during program runtime, resulting in discontinuity and irregularity of data access. Due to the irregularity of this access pattern, indirect access usually leads to a low cache hit rate because the data access pattern does not align with the physical layout in memory, making it difficult to exploit the spatial locality of the cache. This type of indirect memory access pattern is prevalent in computations involving the CSR format, as mentioned above.

Difference is a computational method primarily applied to a sequence or, in this context, a data stream. For a sequence or data stream, each term (except the first one) is subtracted from its preceding term to generate a new sequence or data stream, which can be referred to as the difference of the original sequence or data stream. Differential matching involves comparing two differenced sequences to identify their identical portions.

In today's graph computing and operations related to sparse matrices, irregular computation patterns are prevalent. This type of memory access pattern involves irregular accesses to the memory, meaning that the data addresses being accessed exhibit a certain degree of randomness. Such an access pattern poses challenges to cache architectures and prefetching strategies, often resulting in a high cache miss rate. This, in turn, increases memory access latency and severely impacts computational performance.

Currently, traditional data prefetchers often employ a single prefetch trigger mode when identifying corresponding memory access patterns, and the lookahead and priority configured for the prefetched data block are typically fixed. The aforementioned design makes it difficult to control the timeliness of prefetching. If the prefetched data enters the Cache too early relative to the CPU's request timing, the Cache replacement mechanism may evict the prefetched data, leading to a cache miss when the CPU eventually requests the data. Conversely, if the prefetched data is issued too late relative to the CPU's request timing, the prefetch request may still be awaiting the return of the response data when the CPU requests the data. The timeliness of prefetching directly impacts the Cache hit rate during normal memory access issuance by the CPU.

### SUMMARY OF THE DISCLOSURE

In order to solve the above problems, the present disclosure provides a scheduling method of a data prefetcher for handling indirect accesses, including the steps of:
S100: constructing a data prefetcher that handles irregular accesses;
S200: implementing, with the data prefetcher, identification of an indirect access pattern and address prediction based on differential matching between index data and an indirect access address, and dividing indirect accesses into different range groups to perform prefetch scheduling according to the range groups.

In addition, the present disclosure discloses a scheduler of a data prefetcher for handling indirect accesses, including:
an apparatus for constructing a data prefetcher that handles irregular accesses; and
an apparatus for implementing, with the data prefetcher, identification of an indirect access pattern and address prediction based on differential matching between index data and an indirect access address, and dividing indirect accesses into different range groups to perform prefetch scheduling according to the range groups.

In addition, a computer storage medium is disclosed by the present disclosure, wherein the storage medium includes computer instructions which, when run on a computer, cause the computer to perform the method.

Also disclosed is an electronic device, wherein the electronic device includes:
a memory, a processor and a computer program stored on the memory and executable on the processor, wherein,
the processor implements the method when executing the program.

Through the aforementioned technical solution, this method proposes a scheduling method of a data prefetcher for handling indirect accesses. This data prefetcher, known as DMP (Differential Matching Prefetcher), is designed to address data scheduling issues arising from irregular accesses in out-of-order environments. Leveraging differential matching between index data and indirect access addresses, the DMP is capable of capturing indirect access patterns and predicting addresses. It categorizes indirect accesses into different range groups and conducts prefetching scheduling based on these groups, thereby enhancing the timeliness of prefetched data, improving the accuracy of data prefetching, and increasing the coverage rate. Moreover, the DMP data prefetcher boasts an extremely low hardware resource overhead.

### BRIEF DESCRIPTION OF DRAWINGS

FIG. 1 is a flowchart of a scheduling method of a data prefetcher for handling indirect accesses provided in an embodiment of the present disclosure.

FIG. 2 is a block diagram of the overall structure of a DMP provided in an embodiment of the present disclosure.

FIG. 3 is a schematic diagram of a differential matching module provided in an embodiment of the present disclosure.

FIG. 4 is entries of a prefetch queue provided in an embodiment of the present disclosure.

FIG. 5 is entries of an indirect relation table provided in an embodiment of the present disclosure.

FIG. 6 is a flowchart of a BFS algorithm provided in an embodiment of the present disclosure.

FIG. 7 is a schematic diagram of prefetch priority allocation and scheduling provided in an embodiment of the present disclosure.

FIG. 8 is a schematic diagram of prefetch lookahead dynamic adjustment and prefetch address generation provided in an embodiment of the present disclosure.

FIG. 9 is a prefetch lookahead dynamic adjustment status machine provided in an embodiment of the present disclosure.

FIG. 10 is a schematic diagram of CSR prefetch restriction identification provided in an embodiment of the present disclosure.

FIG. 11 is a a schematic diagram of a prefetch trigger mode provided in an embodiment of the present disclosure.

FIG. 12 is a comparative chart illustrating the prefetch coverage rates for different sparse matrices provided in an embodiment of the present disclosure.

FIG. 13 is a comparative chart illustrating the prefetch timeliness rates for different sparse matrices provided in an embodiment of the present disclosure.

FIG. 14 is a comparative chart illustrating the prefetch accuracy rates for different sparse matrices provided in an embodiment of the present disclosure.

### DETAILED DESCRIPTION OF THE DISCLOSURE

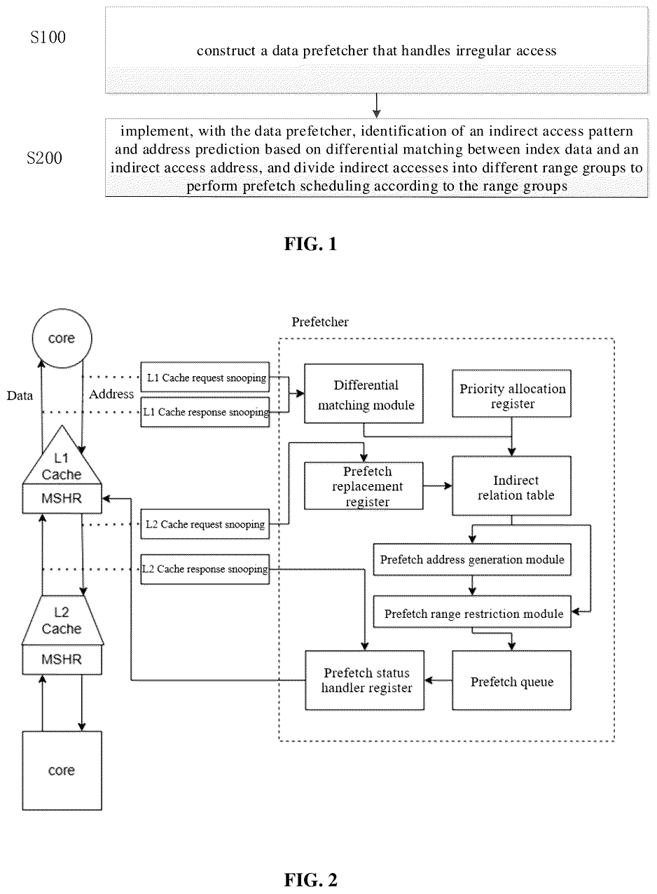

In one embodiment, as illustrated in FIG. 1, the present disclosure provides a scheduling method of a data prefetcher for handling indirect accesses, including the steps of: S100: a data prefetcher that handles irregular accesses is constructed;

S200: with the data prefetcher, identification of an indirect access pattern and address prediction are implemented based on differential matching between index data and an indirect access address, and indirect accesses are divided into different range groups to perform prefetch scheduling according to the range groups.

In terms of this embodiment, the proposed method is primarily applicable in chip architectures that employ a multi-level memory structure. It enables the identification of irregular indirect access patterns and facilitates reasonable scheduling of prefetching, thereby reducing the overhead of cache resources caused by premature prefetching, enhancing the timeliness of prefetching, and improving the operational efficiency of the computing architecture.

In another embodiment, the data prefetcher includes a differential matching module, a priority allocation register, a prefetch replacement register, an indirect relation table, a prefetch address generating module, a prefetch range restriction module, a prefetch queue, and a prefetch status handler register.

In terms of this embodiment, the DMP is divided into eight components, which are located in the L1 Cache in the CPU memory access hierarchy. Simultaneously, it needs to be capable of snooping on events related to access requests and data responses between the computing core and the L1 Cache, as well as between the L1 and L2 Caches, as specifically illustrated in FIG. 2. The components include a Differential Matching Module, a Priority Allocation Register, a Prefetch Replacement Register, an Indirect Relation Table, a Prefetch Address Generating Module, a Prefetch Range Restriction Module, a Prefetch Queue, and a Prefetch Status Handler Register.

In another embodiment, the differential matching module is responsible for the identification of an indirect access pattern, the priority allocation register and the prefetch replacement register are mainly responsible for two essential pieces of information for prefetch request scheduling, the prefetch address generating module and the prefetch range restriction module are able to constrain a prefetch request, and ultimately the prefetch queue and the prefetch status handler register are responsible for caching the prefetch request and maintaining the status after issuance of the prefetch request.

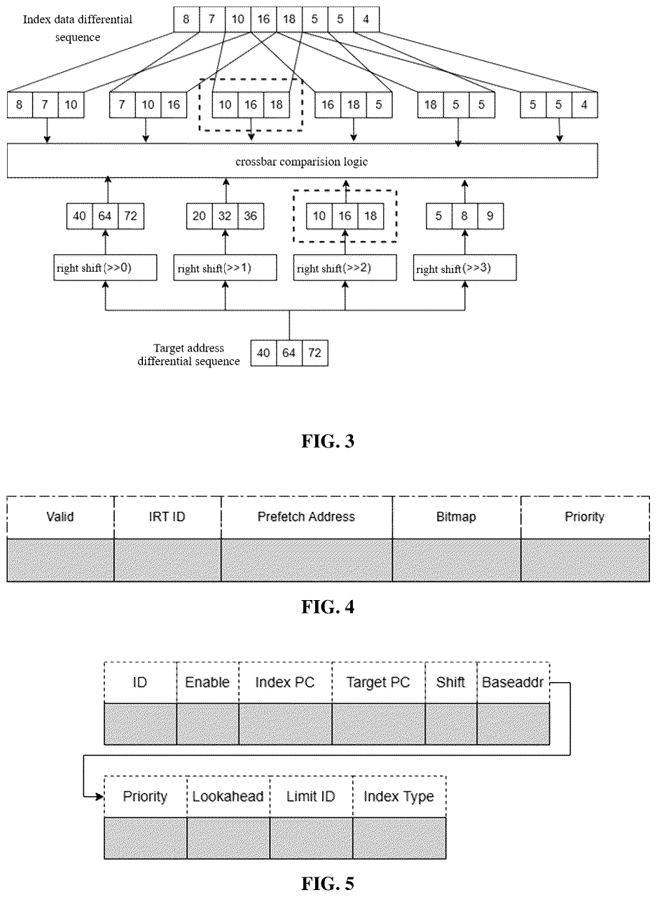

In terms of this embodiment, the differential matching module is the main logic operation functional unit that identifies the indirect access pattern, this module differentiates the data responses transmitted back from the L1 Cache to the computing core (CPU) to obtain a differential sequence of index data. Based on their initial positions, the index data will enter a comparison logic for comparison, as illustrated in FIG. 3. For instance, if the differential sequence of index data is {8,7,10,16,18,5,5,4}, consecutive subsequences of every three terms are extracted from this sequence for comparison. The initial subsequence is {8,7,10}, and the final subsequence is {5,5,4}. These subsequences will then enter into the comparison logic for comparison.

The address information in the data requests sent from the computing core (CPU) to the L1 Cache is subjected to differentiating to obtain a target address differential sequence. This target differential sequence will enter the comparison logic for comparison based on different right-shift bit numbers, as depicted in FIG. 3. For example, if the target address differential sequence is {40,64,72}, this sequence will undergo right shifts of 0, 1, 2, and 3 bits, resulting in sequences ranging from {40,64,72} to {5,8,9}. These sequences will then enter into the comparison logic to be compared with the subsequences of the index data differential sequence. If a match term is found in the comparison logic, it indicates the presence of a corresponding indirect access prefetching relation. This indirect access prefetching relation will be allocated with a priority by the priority allocation register and subsequently recorded in an entry of the indirect relation table.

The priority allocation register stores the currently to-be-allocated range group priority. Upon detecting a new range indirect access, this register allocates its stored priority to the new range access while simultaneously incrementing the value of the register. The prefetch priority is divided into two parts: inter-group priority and intra-group priority. The priority among the range groups increases as the indirect access pattern chain deepens. The priority of indirect accesses within a range group is allocated and incremented directly based on the existing inter-group priority.

A prefetch address generator calculates and generates the final memory access address by looking up the base address, offset, and lookahead in the indirect relation table, and based on the data returned by the L2 Cache. The base address, offset, and lookahead are queried from the table by matching them with the current streaming memory access PC (Program Counter) and index address, ensuring the accuracy of the calculated address. The formula for calculating the prefetch address is as follows:

Prefetch Addr=Base Addr+(Return data«Shift)+(Lookahead«Shift)

The generated data requests will undergo validation by the prefetch range restriction module and will eventually be inserted into the prefetch queue. The prefetch queue then issue the prefetch requests based on the priorities of different prefetch requests. The status of the issued prefetch requests is stored in the prefetch status handler register.

The prefetch range restriction module stipulates that for each range indirect prefetch access pattern, after generating the prefetch address and meeting the identification format of the CSR (i.e., there is a previous case where the same index PC corresponds to multiple target PCs, and the target PC is the present indirect access index PC), the prefetch address of this prefetch operation must fall within the defined upper and lower bounds.

The prefetch replacement register is used to count the number of times a prefetched data block is replaced. This count is used to guide the increase or decrease of the prefetch lookahead. When a prefetched data block in the L1 Cache is replaced, it indicates that there may be an error in the indirect access pattern identification or that the prefetch lookahead is too high. Consequently, the indirect relation table needs to adjust the identified indirect access pattern and its prefetch lookahead based on this metric.

Each prefetch queue will temporarily store the prefetch requests when the MSHR in the L1 Cache is full. During the next scheduling round, the prefetch queue will select the prefetch request with the highest priority for issuance. The corresponding entry content in the prefetch queue is illustrated in FIG. 4, which includes the valid table identification bit (Valid), indicating that the prefetch request in this entry is currently awaiting issuance; the IRT ID, which identifies the position ID of the indirect relation for the prefetch request in the indirect relation table; and the Priority, which represents the current priority of the prefetch request, which is used during scheduling of the prefetch request. When the MSHR is not full, the prefetch request with the highest priority will be transmitted to the prefetch status handler register for final processing of the prefetch request.

The prefetch status handler register (PSHR) is a storage functional unit used to store intermediate information generated during the process of deriving target prefetch addresses from index response data. Its table entries are divided into four parts. The first part is the valid identification bit (Valid), which indicates whether the information in the current entry is valid. The second part stores the ID of the corresponding pattern in the indirect relation table (IRT) (IRT ID). This ID is used to index the corresponding entry information in the IRT. The third part is the prefetch address generated based on the corresponding IRT entry and a specific indirect access pattern. The access requests generated from this address are in a status of awaiting the response from the lower-level storage hierarchy. The fourth part is a sequence (Bitmap) composed of a sequence of 0s and 1s, and is used to recognize which data in the response from the lower level are useful, wherein 1 denotes useful data and 0 denotes useless data. The prefetch status handler register is primarily used to capture and process the data returned from the lower-level hierarchy. Based on the data marked by the Bitmap, information is provided for the address generator for further calculation of the target prefetch addresses.

In another embodiment, the indirect relation table maintains corresponding prefetch lookahead for each entry of the indirect relation table, the prefetch lookahead being dynamically updated.

For this embodiment, the indirect relation table is a storage unit used to store the relation between the streaming memory access and the indirect access. The table entries are divided into seven parts, as illustrated in FIG. 5. The first part (Enable) stores flag information indicating whether the prefetching of the indirect access pattern corresponding to the table entry is enabled. The second and third parts store the index PC and target PC (i.e., the successfully matched index PC and target PC, which can be understood as corresponding to the instructions of load a[i] and load x in the expression x[a[i]], respectively), which are provided by the differential matching module upon successful matching. The fourth part (Base Addr) stores the base address corresponding to the indirect access. Here, LastAddr represents the most recently observed indirect access address in the target table. The fifth part (Shift) stores the number of offset bits used for successful matching within the differential matching module. This number of offset bits is used to calculate the base address of the indirect access and generate the prefetch address. The sixth part (Indirection Type) indicates which of the following four types the indirect access pattern belongs to: single-point non-redundant access, single-point redundant access, single-point redundant-restricted access, and range access. The single-point non-redundant access is a normal single-point indirect access, where single-point prefetch requests are normally generated according to the designed prefetch trigger mode. The single-point redundant access is identified as a redundant single-point indirect access and does not trigger prefetch generation. The single-point redundant-restricted access is identified as an access to CSR format data, and prefetch addresses are generated, but they are not issued as prefetch requests. Instead, the prefetch addresses are updated to the prefetch restriction value (boundary) of the prefetch restriction target table entry in the current table entry, serving as a prefetch restriction for the prefetch restriction target. The range access implies that the access may require generating and issuing multiple prefetch requests to cover the complete distribution range of memory access addresses, and these requests need to pass the validation of the prefetch range restriction module. The seventh part, Priority, represents the priority of each indirect access pattern, which is reflected in the scheduling of the prefetch queue. If there are multiple prefetch schedules in the prefetch queue that need to be processed, the prefetch queue will first issue the prefetch schedule with the highest priority to the prefetch status handler register. Other prefetch requests will be temporarily stored in the prefetch queue until the prefetch status handler register returns that the prefetch request has been processed. For lookahead, in initial stride/indirect access scenarios, a fixed value of lookahead is added to the data address of the index in the index array to obtain the lookahead-adjusted address for prefetching. Boundary is the upper bound of the index in the indirect access pattern, meaning that the addresses corresponding to the prefetch requests triggered by this indirect access pattern cannot exceed this upper bound; otherwise, the corresponding prefetch requests will not be issued. LimitID indicates that the prefetch address generated by the corresponding indirect access pattern should be constrained as the Boundary in the indirect access pattern with the ID of LimitID, rather than being issued as a normal prefetch request.

In another embodiment, after the indirect access pattern is identified, dynamic allocation of a prefetch priority is required, the prefetch priority being determined by the prefetch priority to be allocated and the range group currently located.

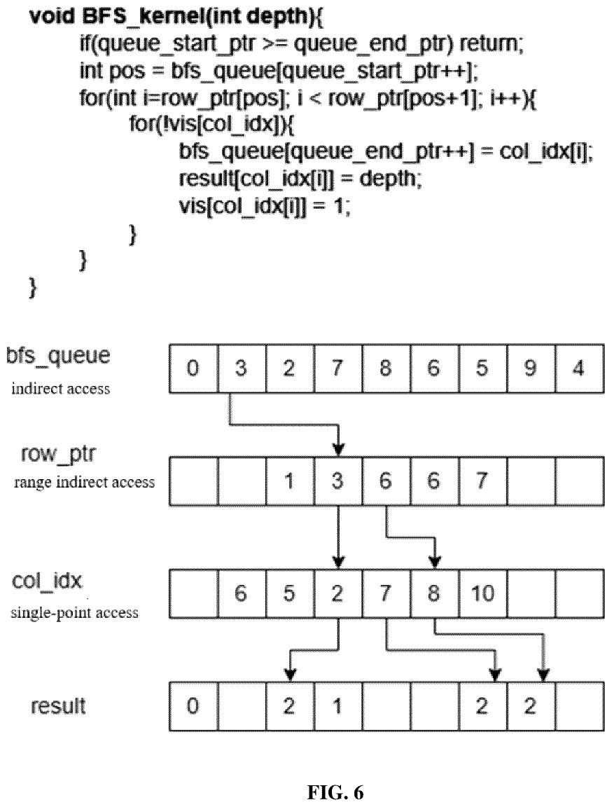

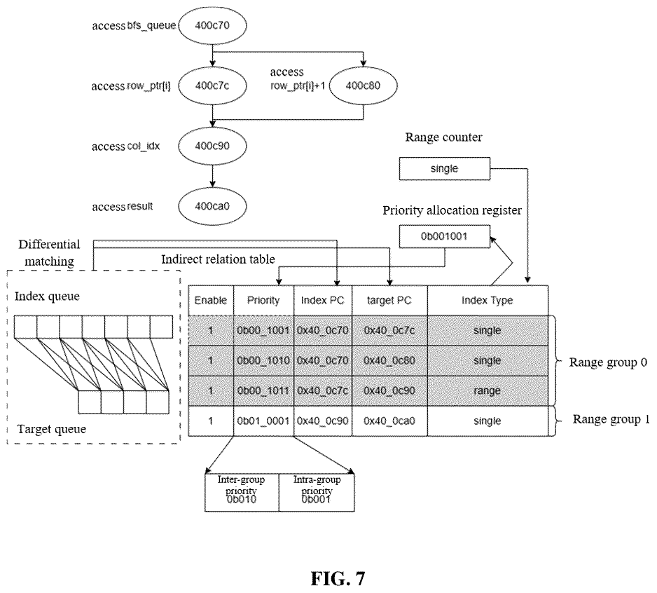

For this embodiment, FIG. 6 shows the code of the proposed method for Breadth-First Search traversal. The entire code encompasses the streaming access to the bfs_queue (i.e., accessing the bfs_queue array with incrementally increasing offset addresses at fixed stride intervals), single-point indirect prefetching of row_ptr, range-based indirect prefetching of col_idx, and single-point indirect prefetching of result. As illustrated in FIG. 6, the memory access instruction for accessing bfs_queue has an instruction address of 0x400c70. The memory access instructions for accessing row_ptr[i], row_ptr[i+1], col_idx, and result have instruction addresses of 0x400c70, 0x400c7c, 0x400c80, 0x400c90, and 0x400ca0, respectively. The memory access data of bfs_queue serves as the offset for row_ptr[i], as demonstrated by examples like row_ptr[3]=3 and row_ptr[4]=6, and row_ptr[i] and row_ptr[i+1] constrain the access range of col_idx. This means that the subsequence of col_idx with an initial address offset of 3 and an ending address offset of 6, which is {2, 7, 8}, needs to be read. The memory access data of col_idx, which is {2, 7, 8}, is then used as the offsets for reading the result array to obtain the values of result [2], result [7], and result [8].

Each indirect access pattern is delineated into a fixed range group. A range group refers to a group of indirect access relations that includes the indirect access relations where the access corresponding to the index PC value in the indirect access dependency chain exhibits a strided access characteristic and all the indirect access relations that start from these indirect access relations as the initial point of the chain and extend until the next range indirect access occurs. As illustrated in FIG. 7, the initial positions of range groups are all the address requests generated after a range indirect access (e.g., load colidx, which involves accessing a certain row of data in the colidx) or a streaming access (e.g., load bfs_queue, which involves accessing the bfs_queue array in a sequential manner). In the indirect access of BFS, the access to bfs_queue is streaming access, while the access to col_idx is range indirect prefetching. Therefore, the indirect access chain from bfs_queue to col_idx is a range group 0, and the indirect access from col_idx to result belong to a range group 1.

After each indirect access pattern is identified, dynamic allocation of a prefetch priority is required, the prefetch priority being determined by the prefetch priority to be allocated and the range group currently located. The prefetch priority is divided into the inter-group priority and the intra-group priority. In the fourth entry of the indirect prefetch table, the priority is set to be 0b010001, wherein the higher 3 bits (0b010) represent the inter-group priority and the lower 3 bits (0b001) represent the intra-group priority. After each priority allocation, the priority in the priority allocation register is incremented. If the next identified indirect access pattern belongs to a new range group, the inter-group priority is incremented by 1. If the next identified indirect access belongs to the previous range group, the inter-group priority is inherited, and the intra-group priority is incremented by 1.

The allocation and scheduling of prefetch priorities can assign different prefetch priorities to the indirect access relations within the indirect access dependency chain formed in multiple nested loops. Generally, the iteration count of deeper loops is significantly higher than that of shallower loops. Consequently, deeper access requests in the indirect access dependency chains occur more frequently than shallower ones. After allocating the priorities among the different indirect access relations based on the range groups, it can be achieved that the deeper the level of indirect access, the higher the prefetch priority. This aligns with the order in which different indirect access relations within the indirect access dependency chain are identified.

In another embodiment, there is an indirect access pattern scheduling approach involving prefetch lookahead adjustment: the initial stride access of each range group serves as index data to perform prefetching for the lower-level indirect access. The prefetch lookahead refers to adding an advance amount during the initial stride access or range indirect access of each range group. When executing the load col_idx instruction, the CPU needs to fetch the data of col_idx that locates within the address range from row_ptr[i] to row_ptr[i+1]. In practical prefetch address calculation, the original calculation method involves adding the base address to the target data right-shifted by the corresponding offset bits. The calculation process is as follows: 0x60_3170 (base address)+target data<<2 (offset bit number). Here, the base address and offset bit number are obtained through indirect queries, and the target data is the data returned to the CPU from the L1 Cache when snooping the memory access to row_ptr[i]. The prefetch lookahead is increased to the originally calculated prefetch address. During loop iterations, the prefetch address with the prefetch lookahead is issued into the prefetch queue. Eventually, the calculation method is modified to: 0x60_3170 (base address)+target data<<2 (offset bit number)+3 (prefetch lookahead)<<2 (offset bit number).

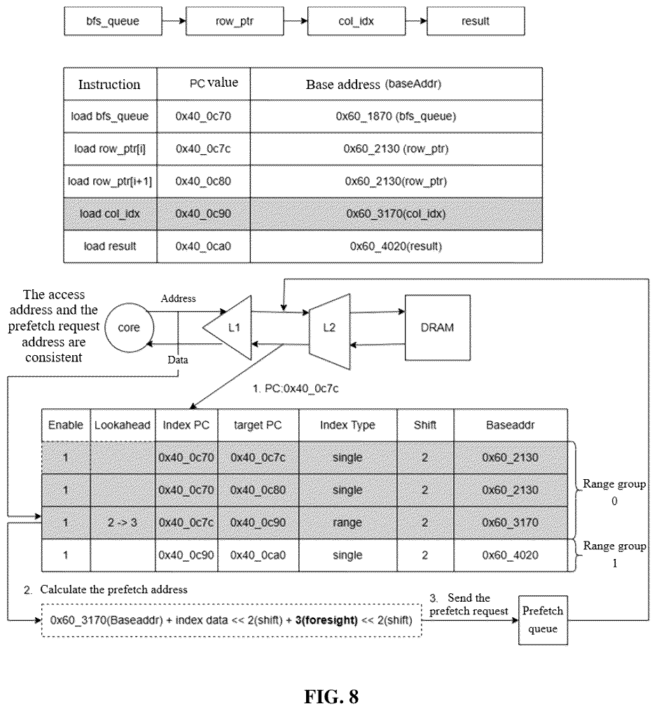

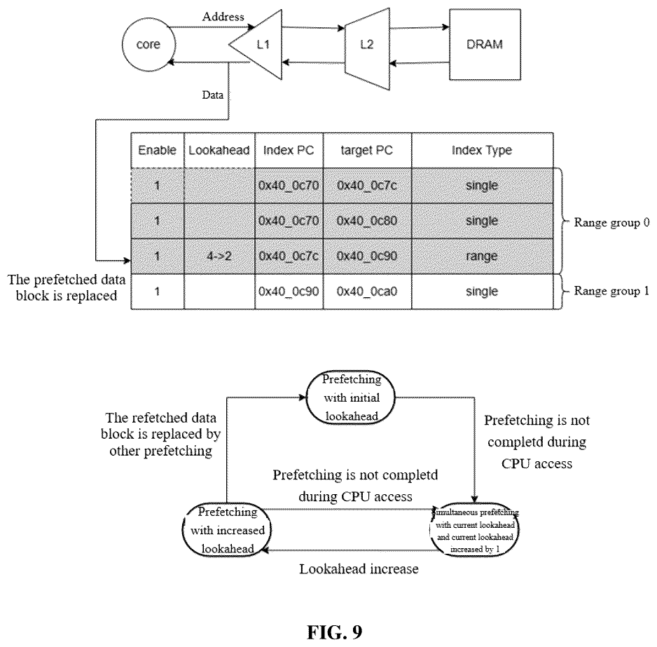

The indirect relation table maintains a corresponding prefetch lookahead for each of its entries, and the lookahead is dynamically updated through two modes: increasing the prefetch lookahead and resetting the prefetch lookahead. In an example depicted in FIG. 8, the default value of the prefetcher lookahead is 2. When the memory access address matches the memory access address generated by a prefetch request in the MSHR, the corresponding prefetch lookahead is increased. As illustrated in FIG. 8, when the address of a data request issued by the CPU is identified to be the same as the address of the prefetch request generated by the entry 3, the prefetch lookahead maintained for the entry of the indirect relation table undergoes a cumulative increment, increased from 2 to 3. When data block replacement occurs in the L1 Cache, the prefetch lookahead reset is required. As illustrated in FIG. 9, if a prefetched data block is replaced and this data block is generated by a prefetch request of the entry 3, then the prefetch lookahead for the entry is reset, from 3 back to 2.

The bottom half of FIG. 9 illustrates a schematic diagram of the lookahead update for prefetching. The increase in the prefetch lookahead involves two stages. In stage one, prefetching address generation is performed using the index data from the prefetch lookahead position and the position where the prefetch lookahead is incremented by one in the current range group. In stage two, the value of the prefetch lookahead is then incremented by one. This two-stage design ensures that no data is missed when the prefetch lookahead is increased.

Due to the non-fixed actual time overhead for the completion of prefetch requests and the potential existence of dependencies between range groups, for instance, when accesses to a PC value of 400c90 in a range group 1 encounter exceptionally long consecutive addresses, a significant number of CPU accesses may remain within the range group 1. Once the number of accesses exceeds a certain threshold, the CPU's access requests for data in the range group 1 might replace the prefetched data of a range group 0. This, in turn, disrupts the ideal balance of the prefetch lookahead in static prefetch scheduling. In summary, adopting the aforementioned dynamic prefetch lookahead mechanism reduces the impact of input data on prefetch scheduling, enhances the robustness of the prefetching strategy, and improves the timeliness of prefetch requests.

In another embodiment, there is an indirect access pattern scheduling approach involving prefetch range restriction. When executing a load col_idx instruction, the CPU needs to fetch the data of col_idx located within the address range from row_ptr[i] to row_ptr[i+1]. In this case, the prefetch lookahead range and the prefetch size must be confined within the interval between row_ptr[i] and row_ptr[i+1]. This prefetching pattern exhibits a fixed characteristic. Specifically, the addresses accessed by the two memory access instructions for row_ptr have indirect access relations with the load bfs_queue instruction at the address 0x400c70. When these two sets of indirect access relations are identified, and the Index PC values are the same, i.e., the index PC values in both entry 0 and entry 1 are 0x400c70, and the subsequent indirect access relation in the indirect access chain is a range access, that is, the Index Type in the entry 2 corresponding to the load col_idx instruction is range, and this instruction relies on the load row_ptr[i] instruction at the address 0x400c7c to provide the initial position and the load row_ptr[i+1] instruction at the address 0x40080 to provide the ending position, which is reflected in the entries as the Index PC in the entry 2 being the instruction address of load row_ptr[i], then entries 0 and 1 will impose constraints on the prefetch range of the entry 2. In the indirect relation table, the limit ID values for the entries 0 and 1 are set to 2, indicating that the prefetched data generated by the entries 0 and 1 will constrain the prefetch addresses of entry 2.

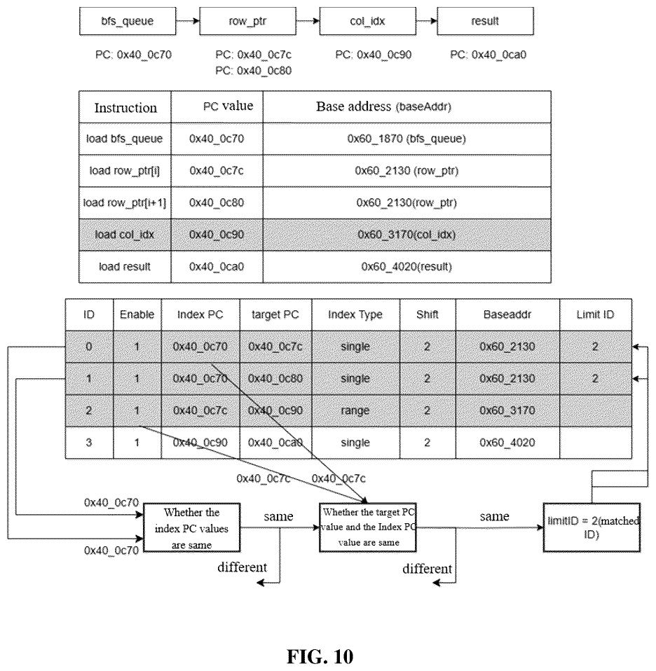

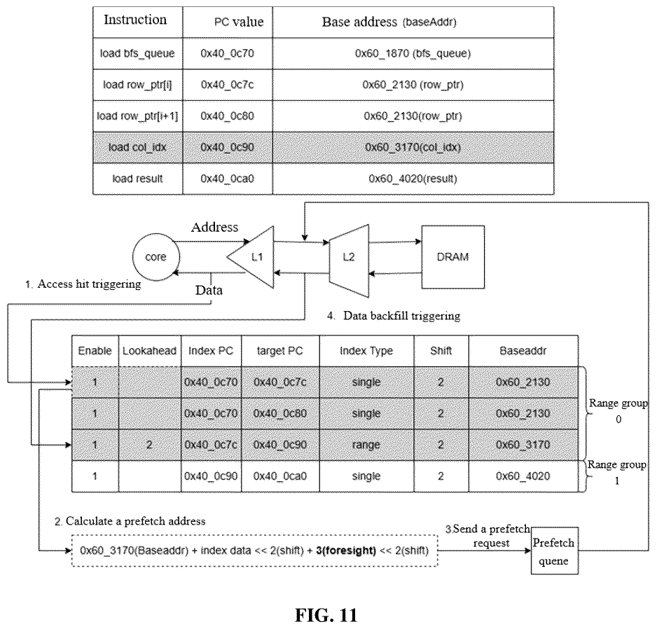

The data responses returned by the entries in an indirect prefetch pattern table that have LimitID are recorded in the range restriction module. In FIG. 10, the data responses corresponding to the entry 0 and entry 1 for the prefetch requests are row_ptr[i]=3 and row_ptr[i+1]=6, respectively. When the entry with LimitID=2 generates a prefetch address, it will constrain the prefetch address based on the previously prefetched values to form upper and lower bounds. That is, the offset of load col_idx plus the prefetch lookahead should fall within the range of 3 to 6. If the address is within this constrained range, the data prefetch request will be issued normally. If it is outside this range, the data request will be discarded.

Although incorporating the prefetch lookahead to prefetch the indirect accesses in advance enhances the timeliness of prefetching, at the end of a sequence of locally contiguous access addresses, the aggressive prefetching is futile as the prefetched data will not be accessed by the CPU in the near future, thereby increasing the likelihood that the prefetched data is replaced. Therefore, imposing prefetch range restrictions to constrain the upper and lower bounds of the prefetch lookahead can effectively reduce unnecessary prefetch after the conclusion of locally contiguous accesses, thereby improving the available capacity of the cache and the prefetching effectiveness of the DMP.

In another embodiment, a prefetch trigger mode of the prefetch scheduling employs a hybrid trigger mode in which access hit triggering and data backfill triggering are mixed.

For this embodiment, there are two prefetch trigger modes. One mode is to trigger prefetching when a normal access request issued by the CPU hits the L1 Cache, which is generally referred to as access hit triggering, and the other mode is to trigger prefetching in response to data backfill after the L1 Cache issues a request to the L2 Cache when a miss occurs, which is generally referred to as data backfill triggering. Access hit triggering is performed on an initial indirect relation table entry in each range group. That is, when the CPU executes onto the corresponding index PC, the prefetch operation is initiated. For other indirect relation table entries, prefetching is triggered by data backfill. In other words, after the data prefetched by the previous indirect prefetch table entry in the range group is returned, the current prefetch operation is triggered. As illustrated in FIG. 11, when the load bfs_queue instruction (with a PC value of 0x400c70) is executed, the access hit by the CPU to the L1 Cache triggers a prefetch request for the indirect relation table entry with an index PC of 0x400c70. This access hit triggers the initial indirect relation table entry in the range group 0. After calculating the prefetch request address and issuing the prefetch request to the L2 Cache, when the L2 Cache backfills the data back to the L1 Cache, it triggers the prefetching of other table entries dependent on the entry 1 in the range group 0. Specifically, since the index PC 0x400c7c in the table entry 3 is the same as the target PC in the table entry 1, when the prefetching of the table entry 3 is triggered by the data backfill, the prefetch request is issued to the L2 Cache for processing.

The trigger time of the access hit trigger mode is closely tied to the normal access requests of the CPU. Consequently, the time interval between the prefetch requests generated by this trigger mode and the actual access requests issued by the CPU is often short, thus ensuring the timeliness of prefetching. However, this trigger mode necessitates that the index data exists in the L1 Cache, a characteristic that restricts the prefetch coverage rate when using access hit events to trigger prefetching. However, the data backfill trigger mode can guarantee that the prefetcher will definitely obtain the index data. Nevertheless, due to the fact that data backfill often does not occur synchronously with the PC actually being executed by the CPU, it results in the prefetching taking place either too early or too late.

The hybrid trigger mode combines the advantages of the aforementioned two prefetching trigger modes, enabling effective regulation of both the timeliness of prefetching and the prefetch coverage. The normal access triggering on the initial indirect access pattern in the range group ensures synchronization with the current instruction stream of the CPU. Meanwhile, the data backfill triggering for the remaining indirect access patterns guarantees that prefetching can continue smoothly along the indirect access dependency chain, thus preventing the interruption of the prefetching chain due to the unavailability of index data.

In another embodiment, the data prefetcher is located in a L1 cache of a CPU memory access hierarchy.

In another embodiment, the primary metrics currently used to evaluate the performance of a prefetcher are the prefetch coverage rate, prefetch timeliness rate, and prefetch accuracy rate. The prefetch coverage rate refers to the proportion of Cache misses reduced by prefetching out of the total number of Cache misses that would occur without prefetching. Prefetch timeliness measures the number of prefetch requests where the data was actually accessed by the CPU and had not been replaced by the Cache at the time of access. The prefetch timeliness rate assesses the proportion of such timely prefetch requests out of all valid prefetch requests. The prefetch accuracy rate is the proportion of Cache misses reduced by prefetching out of all prefetch requests issued. The corresponding calculation formulas are presented below.

$$Prefetch coverage rate = \frac{Misses reduced by prefetching}{Misses reduced by prefetching + misses accessed by C P U}$$

$$Prefetch accuracy rate = \frac{Misses reduced by prefetching}{All prefetch requests}$$

$$Prefetch timeliness rate = \frac{Timely prefetch requests}{all valid prefetch requests}$$

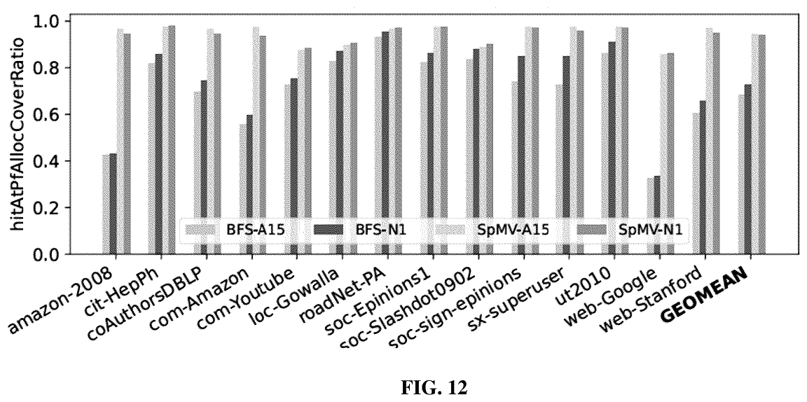

FIGS. 12, 13, and 14 respectively illustrate the prefetch coverage, prefetch timeliness, and prefetch accuracy of this indirect access prefetcher when handling different sparse matrices in practical scenarios. Different parameter configurations are employed when processing each group of matrices.

BFS and SpMV correspond to two sets of algorithms for irregular memory accesses. BFS (Breadth-First Search) is a classic algorithm for graph traversal, which achieves traversal by accessing nodes in the graph layer by layer. In this embodiment, the graph data is stored using the CSR (Compressed Sparse Row) format for sparse matrices. SpMV (Sparse Matrix-Vector Multiplication) is a crucial computational operation, with its core being the multiplication of a sparse matrix by a dense vector. A sparse matrix refers to a matrix with a relatively low proportion of non-zero elements, while a dense vector denotes a vector where most elements are non-zero values.

The simulation experiments in this embodiment employ two sets of system parameters, A15 and N1, to simulate two commercial processors, namely the Arm Cortex-A15 and the Arm Neoverse N1, respectively, which are used to cover the mobile embedded-level and cloud server-level application scenarios. In the configuration of the DMP (Dynamic Prefetching Mechanism) prefetcher, the length of the intra-group priority is set to be 8 bits, meaning that each range group could accommodate 256 indirect access relations. In the dynamic lookahead mechanism, the initial lookahead is set to be 16 byte addresses for the A15 configuration and 24 byte addresses for the N1 configuration. The lookahead reset is triggered when a single prefetch replacement occurs in both configurations. Additionally, the lookahead of the stride prefetcher involved in the experiments is set to be 4 Cache data blocks.

As illustrated in FIG. 12, the prefetch coverage rate and the proportion of prefetches in the MSHR entries exhibit a significant correlation with the prefetch address translation failure rate. When a significant number of prefetch addresses generated by the DMP are discarded due to address translation failures, the actual number of prefetch requests issued decreases accordingly. This leads to a reduction in the proportion of prefetches within the MSHR entries and ultimately results in a lower prefetch coverage rate for indirect accesses. Specifically, in the test matrices of amazon-2008 and web-Google, both the prefetch coverage rate of BFS and the proportion of prefetches in the MSHR entries are below 50%, which significantly constrains the effectiveness of the prefetching mechanism in alleviating the bottleneck of indirect accesses. However, based on the overall test results, DMP achieves an average prefetch coverage rate of 94% in the SpMV test and 70% in the BFS test.

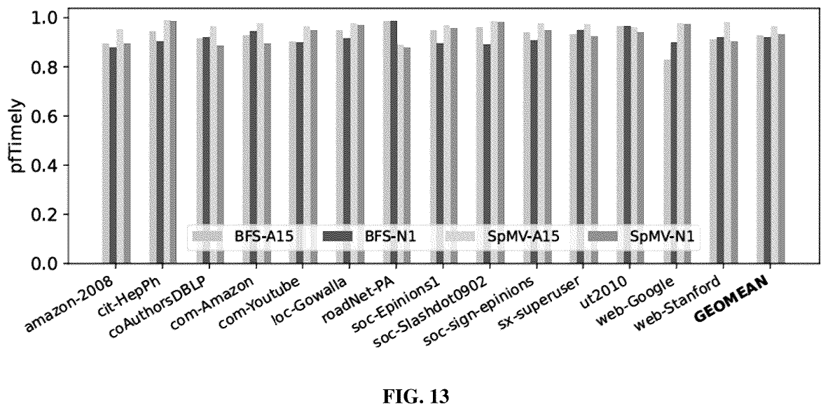

As illustrated in FIG. 13, the prefetch timeliness rate reflects the proportion of prefetched data that is already available when the CPU accesses it, among all valid prefetch requests issued. Experimental results demonstrate that the dynamic prefetch lookahead mechanism (DMP) can achieve a relatively stable and high timeliness rate across all tested matrices. Specifically, DMP attains an average prefetch timeliness rate of 95% for the SpMV algorithm and 92% for the BFS algorithm. These figures amply validate the notable superiority of DMP in ensuring the availability of prefetched data, which can effectively guarantee that the prefetched data is ready when accessed by the CPU, thereby enhancing the overall system performance.

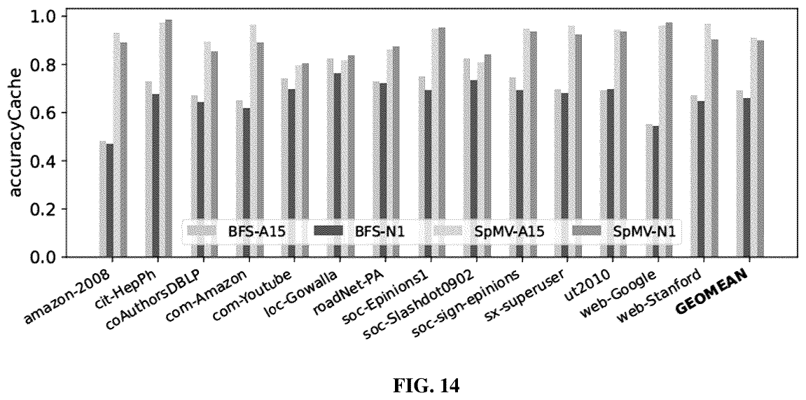

As illustrated in FIG. 14, the prefetch accuracy rate indicates the proportion of effective prefetch requests among all the actual prefetch requests issued. Since DMP employs a range prefetching restriction mechanism, the aggressiveness of range prefetching is effectively constrained and the proportion of effective prefetches is significantly increased by imposing upper and lower bounds on prefetch request addresses. Experimental data reveals that DMP achieves average prefetch accuracy rates of 92% and 66% in the SpMV and BFS tests, respectively. This outcome demonstrates that DMP can substantially enhance prefetching performance in most test scenarios, effectively minimizing the number of ineffective prefetch requests, and consequently improving system resource utilization and overall performance.

In another embodiment, a scheduler of data prefetcher for handling indirect accesses includes:
an apparatus for constructing a data prefetcher that handles irregular accesses; and
an apparatus for implementing, with the data prefetcher, identification of an indirect access pattern and address prediction based on differential matching between index data and an indirect access address, and dividing indirect accesses into different range groups to perform prefetch scheduling according to the range groups.

Furthermore, a computer storage medium is disclosed, wherein the storage medium includes computer instructions which, when run on a computer, cause the computer to perform the method of any one of the preceding claims.

Also disclosed is an electronic device, wherein the electronic device includes:
a memory, a processor and a computer program stored on the memory and executable on the processor, wherein,
the processor implements the method of any one of the preceding claims when executing the program.

Although embodiments of the present disclosure have been described above with reference to the accompanying drawings, the present disclosure is not limited to the above-described specific embodiments and fields of application, and the above-described specific embodiments are merely illustrative and instructive, and are not limiting. Those of ordinary skill in the art, in light of the inspiration of the present specification and without departing from the scope of the claims of the present disclosure, can make a variety of forms, all of which fall within the scope of the disclosure.

1. A scheduling method of a data prefetcher for handling indirect accesses, comprising the steps of:
S100: constructing a data prefetcher that handles irregular accesses;
S200: implementing, with the data prefetcher, identification of an indirect access pattern and address prediction based on differential matching between index data and an indirect access address, and dividing indirect accesses into different range groups to perform prefetch scheduling according to the range groups.

2. The method according to claim 1, wherein the data prefetcher comprises a differential matching module, a priority allocation register, a prefetch replacement register, an indirect relation table, a prefetch address generating module, a prefetch range restriction module, a prefetch queue, and a prefetch status handler register.

3. The method according to claim 2, wherein the differential matching module is responsible for the identification of an indirect access pattern, the priority allocation register and the prefetch replacement register are mainly responsible for two essential pieces of information for prefetch request scheduling, the prefetch address generating module and the prefetch range restriction module are able to constrain a prefetch request, and ultimately the prefetch queue and the prefetch status handler register are responsible for caching the prefetch request and maintaining the status after issuance of the prefetch request.

4. The method according to claim 2, wherein the indirect relation table maintains corresponding prefetch lookahead for each entry of the indirect relation table, the prefetch lookahead being dynamically updated.

5. The method according to claim 1, wherein after the indirect access pattern is identified, dynamic allocation of a prefetch priority is required, the prefetch priority being determined by the prefetch priority to be allocated and the range group currently located.

6. The method according to claim 1, wherein a prefetch trigger mode of the prefetch scheduling employs a hybrid trigger mode in which access hit triggering and data backfill triggering are mixed.

7. The method according to claim 1, wherein the data prefetcher is located in a L1 cache of a CPU memory access hierarchy.

8. A scheduler of a data prefetcher for handling indirect accesses, comprising:
an apparatus for constructing a data prefetcher that handles irregular accesses; and
an apparatus for implementing, with the data prefetcher, identification of an indirect access pattern and address prediction based on differential matching between index data and an indirect access address, and dividing indirect accesses into different range groups to perform prefetch scheduling according to the range groups.

9. A computer storage medium, wherein the storage medium comprises computer instructions which, when run on a computer, cause the computer to perform the method according to claim 1.

10. An electronic device, wherein the electronic device comprises:
a memory, a processor and a computer program stored on the memory and executable on the processor, wherein, the processor implements the method according to claim 1 when executing the program.

11. The computer storage medium of claim 9, wherein the data prefetcher comprises a differential matching module, a priority allocation register, a prefetch replacement register, an indirect relation table, a prefetch address generating module, a prefetch range restriction module, a prefetch queue, and a prefetch status handler register.

12. The computer storage medium of claim 11, wherein the differential matching module is responsible for the identification of an indirect access pattern, the priority allocation register and the prefetch replacement register are mainly responsible for two essential pieces of information for prefetch request scheduling, the prefetch address generating module and the prefetch range restriction module are able to constrain a prefetch request, and ultimately the prefetch queue and the prefetch status handler register are responsible for caching the prefetch request and maintaining the status after issuance of the prefetch request.

13. The computer storage medium of claim 11, wherein the indirect relation table maintains corresponding prefetch lookahead for each entry of the indirect relation table, the prefetch lookahead being dynamically updated.

14. The computer storage medium of claim 9, wherein after the indirect access pattern is identified, dynamic allocation of a prefetch priority is required, the prefetch priority being determined by the prefetch priority to be allocated and the range group currently located.

15. The computer storage medium of claim 9, wherein a prefetch trigger mode of the prefetch scheduling employs a hybrid trigger mode in which access hit triggering and data backfill triggering are mixed.

16. The computer storage medium of claim 9, wherein the data prefetcher is located in a L1 cache of a CPU memory access hierarchy.

17. The electronic device of claim 10, wherein the data prefetcher comprises a differential matching module, a priority allocation register, a prefetch replacement register, an indirect relation table, a prefetch address generating module, a prefetch range restriction module, a prefetch queue, and a prefetch status handler register.

18. The electronic device of claim 17, wherein the differential matching module is responsible for the identification of an indirect access pattern, the priority allocation register and the prefetch replacement register are mainly responsible for two essential pieces of information for prefetch request scheduling, the prefetch address generating module and the prefetch range restriction module are able to constrain a prefetch request, and ultimately the prefetch queue and the prefetch status handler register are responsible for caching the prefetch request and maintaining the status after issuance of the prefetch request.

19. The electronic device of claim 17, wherein the indirect relation table maintains corresponding prefetch lookahead for each entry of the indirect relation table, the prefetch lookahead being dynamically updated.

20. The electronic device of claim 10, wherein after the indirect access pattern is identified, dynamic allocation of a prefetch priority is required, the prefetch priority being determined by the prefetch priority to be allocated and the range group currently located.
